(19) United States
(12) Patent Application Publication
(10) Pub. No.: US 2009/0167240 A1
(43) Pub. Date: Jul. 2, 2009

(54) Electric battery booster

(76) Inventor: Sandra Marie, Hampton, VA (US)

Correspondence Address: Sandra Copling, 1585 Briarfield Rd, Hampton, VA, 23669, US

(21) Appl. No.: 12/217,600

(22) Filed: Nov. 14, 2008

Related U.S. Application Data
(60) Provisional application No. 60/958,154, filed on Jul. 5, 2007.

(51) Int. Cl. H02J 7/00

(52) U.S. Cl. 320/107

(57) ABSTRACT

The device that I invented is used to save gas. It can be placed under the hood of any car. What makes my device different is that it has an electric panel and battery panel stored in the housing of the battery. It is then placed under the hood to be connected to the starter to ensure proper connection. It can also be switched from gas to electric and then back from electric to gas.

### THE SPECIFICATIONS

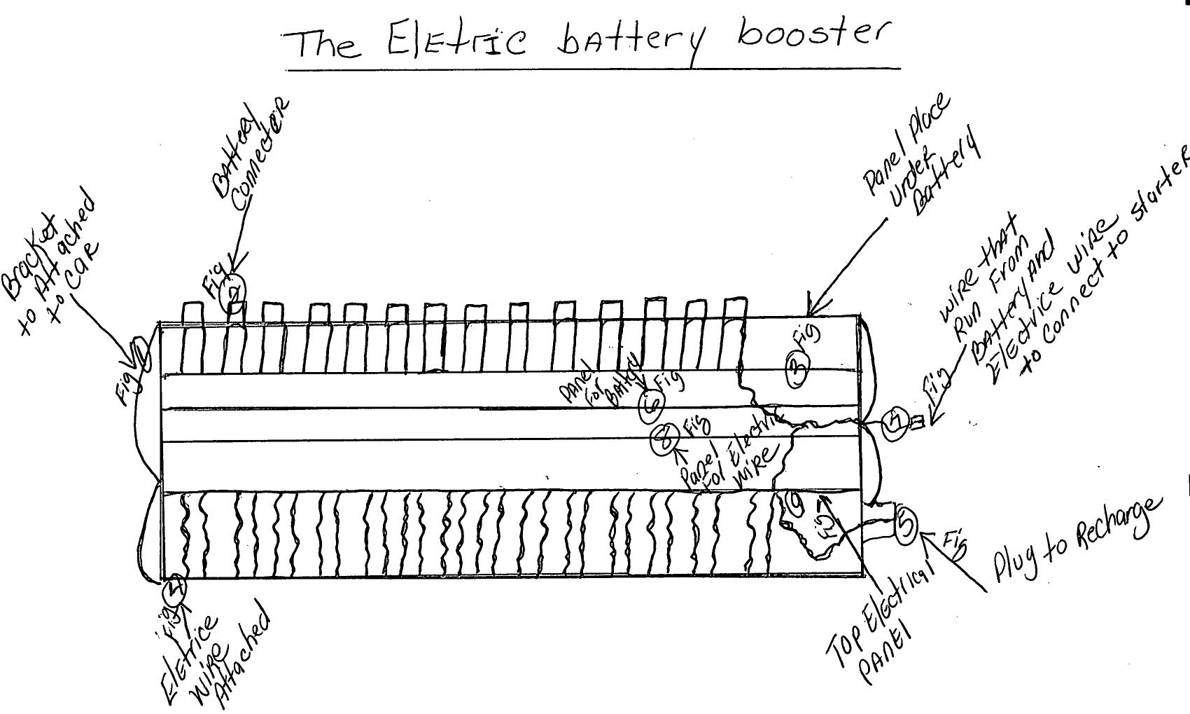

FIG. 1 depicts the component that is attached to the car.

FIG. 2 depicts where the battery connects to the top panel.

FIG. 3 depicts the panel that is stored under the battery.

FIG. 4 depicts the electrical wire that is attached to the bottom panel.

FIG. 5 depicts the socket that the wire is connected to charge the car.

FIG. 6 depicts the panel under the battery.

FIG. 7 depicts the wire that runs from the battery and electrical wires.

FIG. 8 depicts the panel that runs through the device for the electrical current.

FIG. 9 depicts the top panel for the electrical wires.

### CREATION AND DEVELOPMENT

I was meditating on ways to help reduce rising fuel costs and God gave me a vision. I envisioned it in my mind as to how the device would look, and next, I pulled up to my table and began to sketch it on paper, identifying where each part would be attached. It began with the battery and then the battery panel, and I started to develop my design. I then studied on the electrical wire and electrical panel and how many batteries it would take and how much current circulating through the electrical wire to start the engine.

I claim:

1. A self contained electric battery booster the component that is attached to the car to keep the electric battery booster in place. A self contained electric battery booster for charging a vehicle, a fully charged vehicle battery. This is where the battery is connected to the inner battery which delivers current to the starter of the vehicle up under the hood of the car, having a square shape with a front, back, sides, having a panel attached covering the entire housing. On the inside panel is the top panel connected with the battery is the terminal where the battery is stored. The electrical panel is connected to the electrical wire within the terminal voltage equal or less is a electrical panel within where the electric wires plug is connected to the charger battery positive terminal, said receptacle being electrically connected to a common ground connected to the charger. The electrical wire runs from the battery terminal and electrical terminal and the power panel in the middle connected to the starter. The electrical wire runs from one end of the panel to the other then the electrical wire connects together to the electrical panel and down to an electrical wire into the connecting housing adapter for to be plugged up and recharged. This is how the entire device functions: The manufacturer places a switch on the gas line of each car to keep the flow of gas from entering in until needed. This will let the electric battery booster work until it needs to be recharged. Then, when the electric battery booster runs down, the driver can switch over to gas fuel.
